(19) United States
(12) Patent Application Publication
(10) Pub. No.: US 2019/0211141 A1
(43) Pub. Date: Jul. 11, 2019

(54) AROMATIC POLYKETONE HAVING TWO DIFFERENT STRUCTURAL UNITS

(71) Applicant: HITACHI CHEMICAL COMPANY, LTD., Tokyo (JP)

(72) Inventors: Hiroshi MATSUTANI, Chiyoda-ku, Tokyo (JP); Nanako ARIMA, Chiyoda-ku, Tokyo (JP); Yohei ISHIKAWA, Chiyoda-ku, Tokyo (JP); Keiko KUDOH, Chiyoda-ku, Tokyo (JP); Katsuya MAEYAMA, Yamagata-shi, Yamagata (JP)

(21) Appl. No.: 16/307,792

(22) PCT Filed: May 26, 2017
(86) PCT No.: PCT/JP2017/019807

§ 371 Date: Dec. 6, 2018

(30) Foreign Application Priority Data
Jun. 10, 2016 (JP) 2016-116086

(51) Int. Cl. C08G 61/02; C09D 173/00; G02B 5/30; G02F 1/1333

(52) U.S. Cl. CPC C08G 61/02; C09D 173/00; G02B 5/30; G02F 1/1333; C08G 2261/3323; C08G 2261/314; C08G 2261/3324; C08G 2261/3325; C08G 2261/312

(57) ABSTRACT

A polymer includes: a structural unit represented by the following Formula (I-1) and a structural unit represented by the following Formula (I-2). In Formulae (I-1) and (I-2), X and X′ each independently represent a divalent group having 6 to 50 carbon atoms and containing an aromatic ring; Y represents a divalent group having 5 to 50 carbon atoms, the divalent group including an alicyclic ring and alkylene groups, and the alkylene groups each having 1 to 10 carbon atoms connecting carbon atoms included in carbonyl groups adjacent to Y with the alicyclic ring; Y′ represents a divalent group having 3 to 50 carbon atoms and containing an alicyclic ring directly bonded to carbon atoms included in carbonyl groups adjacent to Y′; and m and n each represent an integer from 3 to 1,000.

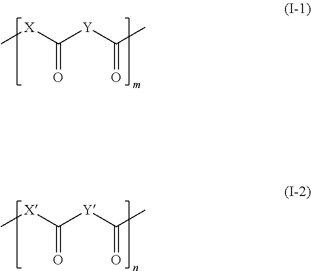

### TECHNICAL FIELD

The present invention relates to an aromatic polyketone having two different structural units.

### BACKGROUND ART

Polymers (aromatic polyketones) having an aromatic ring and a carbonyl group in the main chain thereof have excellent heat resistance and mechanical properties and are utilized as engineering plastics (see, for example, Patent Document 1 and Patent Document 2). Among these, alicyclic polyketones having an alicyclic structure in the main chain thereof have excellent heat resistance and also have excellent transparency and are expected to be applied to optical components (see, for example, Patent Document 3).

When a resin material is applied to an optical component, it is desirable that the material exhibits properties that are unobtainable with an inorganic material, such as lightweightness and flexibility. Examples of applications utilizing lightweightness include glass substitute materials and coating materials for portable devices, and examples of applications utilizing flexibility include flexible displays. In particular, application of resin materials to flexible displays has attracted particular attention in recent years.

### RELATED ART DOCUMENTS

### Patent Document

Patent Document 1 Japanese Patent Application Laid-Open (JP-A) No. S62-7730

Patent Document 2 JP-A No. 2005-272728

Patent Document 3 JP-A No. 2013-53194

### SUMMARY OF INVENTION

### Problems to be Solved by the Invention

A film formed from the aromatic polyketones described in the foregoing documents has excellent transparency and heat resistance, but there is room for improvement of flexibility. Accordingly, development of aromatic polyketones having favorable flexibility while maintaining excellent transparency and heat resistance is desired.

The invention has been made in view of the foregoing circumstances, and an object thereof is to provide a polymer having excellent transparency, heat resistance, and flexibility, and a composition, a film, a film-bearing substrate, an optical element, an image display device, a coating material, and a molded article using this polymer.

### Means for Solving the Problems

Means for solving the above-described problems include the following embodiments.

<1> A polymer, including:

a structural unit represented by the following Formula (I-1); and

a structural unit represented by the following Formula (I-2).

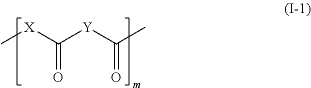

In Formula (I-1), X represents a divalent group including 6 to 50 carbon atoms and an aromatic ring; Y represents a divalent group including 5 to 50 carbon atoms, the divalent group including an alicyclic ring and alkylene groups, and the alkylene groups each having 1 to 10 carbon atoms and connecting carbon atoms included in carbonyl groups adjacent to Y with the alicyclic ring; and m represents an integer from 3 to 1,000.

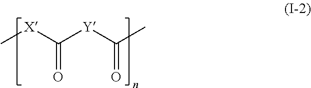

In Formula (I-2), X′ represents a divalent group including 6 to 50 carbon atoms and an aromatic ring; Y′ represents a divalent group including 3 to 50 carbon atoms and an alicyclic ring directly bonded to carbon atoms included in carbonyl groups adjacent to Y′; and n represents an integer from 3 to 1,000.

<2> The polymer according to <1>, wherein, in Formula (I-1) and Formula (I-2), each of X and X′ each independently has from 12 to 50 carbon atoms.
<3> The polymer according to <1> or <2>, wherein X and X′ in Formulae (I-1) and (I-2) each independently represents a group represented by at least one selected from the group consisting of the following Formula (II-1), the following Formula (II-2), and the following Formula (II-3).

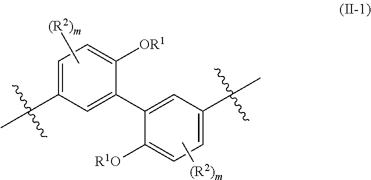

In Formula (II-1), each R¹ independently represents a hydrogen atom or a hydrocarbon group that includes 1 to 30 carbon atoms and that may have a substituent; each R² independently represents a hydrocarbon group that includes 1 to 30 carbon atoms and that may have a substituent; and each m independently represents an integer from 0 to 3.

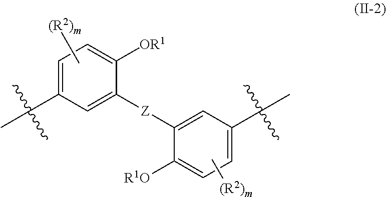

In Formula (II-2), each R independently represents a hydrogen atom or a hydrocarbon group that includes 1 to 30 carbon atoms and that may have a substituent; each R² independently represents a hydrocarbon group that includes 1 to 30 carbon atoms and that may have a substituent; Z represents an oxygen atom or a divalent group represented by the following Formulae (III′-1) to (III′-7); and each m independently represents an integer from 0 to 3.

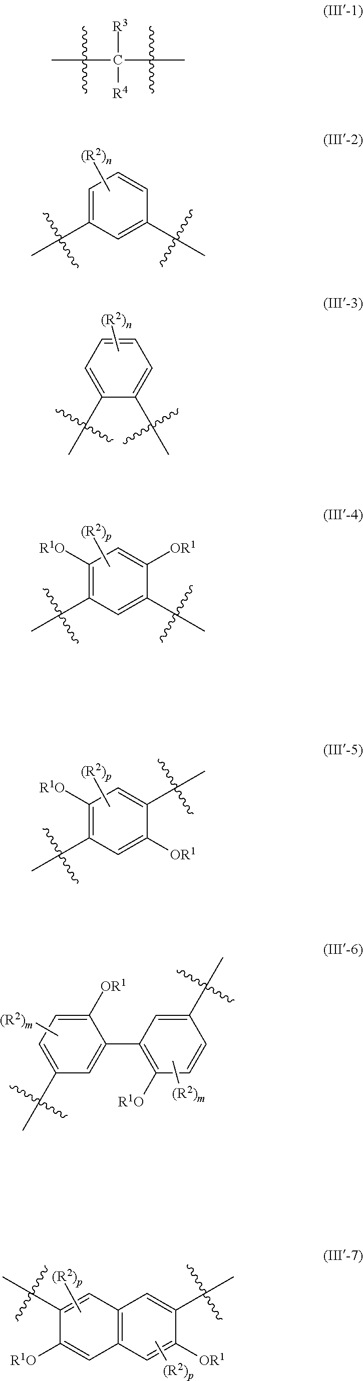

In Formulae (III′-1) to (III′-7), each R¹ independently represents a hydrogen atom or a hydrocarbon group that includes 1 to 30 carbon atoms and that may have a substituent; each R independently represents a hydrocarbon group that includes 1 to 30 carbon atoms and that may have a substituent; R³ and R⁴ each independently represent a hydrogen atom or a hydrocarbon group that includes 1 to 30 carbon atoms and that may have a substituent; each m independently represents an integer from 0 to 3; each n independently represents an integer from 0 to 4; and each p independently represents an integer from 0 to 2.

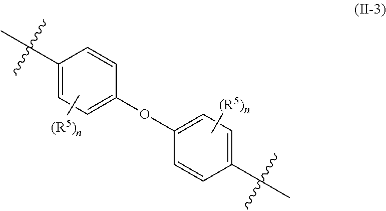

In Formula (II-3), each R⁵ independently represents a hydrocarbon group that includes 1 to 30 carbon atoms and that may have a substituent; and each n independently represents an integer from 0 to 4.

<4> The polymer according to any one of <1> to <3>, wherein, in Formulae (I-1) and (I-2), each of Y and Y′ independently has from 6 to 50 carbon atoms.
<5> The polymer according to any one of <1> to <4>, wherein, in Formulae (I-1) and (I-2), the structure of each alicyclic ring in Y and Y′ independently includes at least one selected from the group consisting of a cyclohexane skeleton, a decahydronaphthalene skeleton, an adamantane skeleton, a norbornane skeleton, and a bicyclo [2.2.2] octane skeleton.
<6> The polymer according to any one of <1> to <5>, wherein, in Formulae (I-1) and (I-2), each of Y and Y′ independently includes at least one alicyclic ring selected from the group consisting of the following Formulae (III-1) to (III-5).

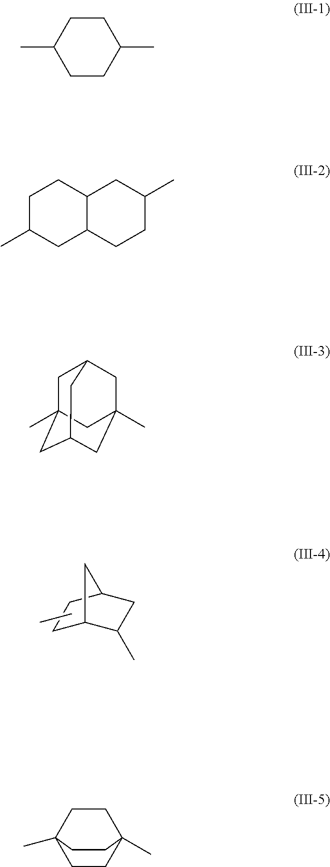

<7> A composition, including the polymer according to any one of <1> to <6>.

<8> The composition according to <7>, further including a solvent.
<9> A film, including the polymer according to any one of <1> to <6>.
<10> A film-bearing substrate, including:

a substrate; and

the film according to <9>, which is provided on at least a part of a surface of the substrate.

<11> An optical element, including the film according to <9> or the film-bearing substrate according to <10>.
<12> An image display device, including the film according to <9> or the film-bearing substrate according to <10>.
<13> A coating material, including the polymer according to any one of <1> to <6>.
<14> A molded article, including the polymer according to any one of <1> to <6>.

### Effects of the Invention

According to the invention, a polymer having excellent transparency, heat resistance, and flexibility, and a composition, a film, a film-bearing substrate, an optical element, an image display device, a coating material, and a molded article using such a polymer are provided.

### DESCRIPTION OF EMBODIMENTS

Hereinafter, the invention will be described in detail. However, the invention is not limited to the following embodiments. In the following embodiments, the constituent elements (including element steps and the like) are not essential unless otherwise specified or considered to be theoretically obviously essential. The same applies to numerical values and ranges thereof, and the invention is not limited by the numerical values and the ranges.

Herein, the term “step” encompasses a step of which the object thereof is achieved even in a case in which the step is unable to be clearly distinguished from another step, as well as a step independent from another step.

Herein, a numerical range expressed by using “x to y” includes the numerical values of x and y in the range as the minimum value and the maximum value, respectively.

In the numerical ranges expressed in a stepwise manner herein, the upper limit value or the lower limit value expressed in one numerical range may be replaced with the upper limit value or the lower limit value in another numerical range in a stepwise manner. In a numerical range expressed herein, the upper limit value or the lower limit value of the numerical value range may be replaced with values described in Examples.

Herein, unless otherwise specified, the content rate or content of each component in a composition means the total content rate or content of plural kinds of substances present in the composition when the plural kinds of substances corresponding to each component exist in the composition.

Herein, unless otherwise specified, the particle size of each component in a composition means a value for a mixture of plural kinds of particles present in the composition when the plural kinds of particles corresponding to each component exist in the composition.

Herein, the term “layer” or “film” encompasses, when observing a region where a layer or film is present, a case in which the layer or the film is formed only on a part of the region in addition to a case in which the layer or the film is formed on the entirety of the region.

The term “layered” or “layering” as used herein refers to stacking of layers, and two or more layers may be bonded, or two or more layers may be removable.

Herein, the term “transparency” means that the visible light permeability, or the transparency of visible light having at least a wavelength of 400 nm is 80% or more (in terms of film thickness of 1 μm).

Herein, the term “heat resistant” means that the Tg is higher than at least 185° C. in a member containing a polymer.

<Polymer>

The polymer according to an embodiment includes: a structural unit represented by the following Formula (I-1); and a structural unit represented by the following Formula (I-2).

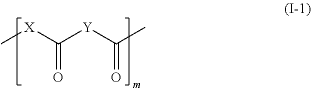

In Formula (I-1), X represents a divalent group having 6 to 50 carbon atoms and containing an aromatic ring; Y represents a divalent group having 5 to 50 carbon atoms, the divalent group including an alicyclic ring and alkylene groups, and the alkylene groups each having 1 to 10 carbon atoms and connecting the carbon atoms included in the carbonyl groups adjacent to Y with the alicyclic ring; and m represents an integer from 3 to 1,000. Plural X's may be the same as or different from each other, and plural Y's may be the same as or different from each other.

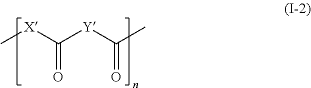

In Formula (I-2), X′ represents a divalent group having 6 to 50 carbon atoms and containing an aromatic ring; Y′ represents a divalent group having 3 to 50 carbon atoms, the divalent group including an alicyclic ring directly bonded to the carbon atoms included in the carbonyl groups adjacent to Y′; and n represents an integer from 3 to 1,000. Plural X″s may be the same as or different from each other, and plural Y″s may be the same as or different from each other.

Since the polymer according the embodiment has the above structure, a film and a molded article having excellent transparency, heat resistance, and flexibility can be formed. Although the reason is not clear, it is believed that the polymer exerts excellent transparency since an aromatic ring and an alicyclic ring are contained in the molecular chain, the polymer exerts excellent flexibility since a part of the alicyclic rings are bonded via alkylene groups to the carbon atoms in the adjacent carbonyl groups, and the polymer exerts excellent heat resistance since a part of the alicyclic rings are directly bonded to the carbon atoms in the adjacent carbonyl groups.

In the polymer according to an embodiment, X and Y in the structural unit represented by Formula (I-1) and X′ and Y′ in the structural unit represented by Formula (I-2) may be the same as or different from each other, respectively.

In the polymer according to an embodiment, the proportions of the structural unit represented by Formula (I-1) and the structural unit represented by Formula (I-2) are not particularly limited. The ratio of the number m in the structural unit represented by Formula (I-1) to the number n in the structural unit represented by Formula (I-2) preferably satisfies m:n=5:95 to 95:5 from the viewpoint of heat resistance, the ratio more preferably satisfies m:n=5:95 to 80:20 from the viewpoints of heat resistance and transparency, and the ratio still more preferably satisfies m:n=5:95 to 70:30 from the viewpoint of heat resistance and solubility in a solvent. When the solubility in a solvent is favorable, even a polymer having a larger molecular weight tends to be sufficiently dissolved in a solvent and a film having excellent flexibility tends to be formed.

In Formulae (I-1) and (I-2), each of X and X′ independently preferably has from 12 to 50 carbon atoms from the viewpoint of heat resistance, and each of X and X′ independently preferably has from 12 to 30 carbon atoms from the viewpoint of transparency. It is preferable that each of X and X′ independently contains two or more aromatic rings, and more preferable that each of X and X′ independently contains two or more benzene rings.

From the viewpoints of heat resistance and transparency, in Formulae (I-1) and (I-2), it is preferable that each of X and X′ independently represents a group represented by at least one selected from the group consisting of the following Formula (II-1), Formula (II-2), and Formula (II-3).

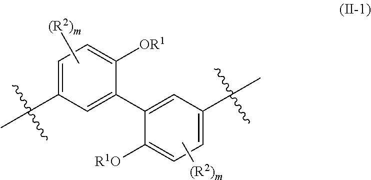

In Formula (II-1), each R¹ independently represents a hydrogen atom or a hydrocarbon group that has 1 to 30 carbon atoms and that may have a substituent; each R² independently represents a hydrocarbon group that has 1 to 30 carbon atoms and that may have a substituent; and each m independently represents an integer from 0 to 3. The wavy line indicates a binding site, and the same is applied in the following.

From the viewpoint of heat resistance, R¹ is preferably a hydrocarbon group having 1 to 10 carbon atoms which may have a substituent, and from the viewpoint of reaction control, R¹ is more preferably a hydrocarbon group having 1 to 5 carbon atoms which may have a substituent.

Examples of the hydrocarbon group represented by R¹ include a saturated aliphatic hydrocarbon group, an unsaturated aliphatic hydrocarbon group, an alicyclic hydrocarbon group, and a combination of these hydrocarbon groups.

When the hydrocarbon group represented by R¹ has a substituent, examples of the substituent include a halogen atom, a hydroxyl group, an epoxy group, an oxetanyl group, an alkoxy group having 1 to 5 carbon atoms, and an acyl group having 2 to 5 carbon atoms. When the hydrocarbon group represented by R¹ has a substituent, the number of carbon atoms of the hydrocarbon group does not include the number of carbon atoms of the substituent.

Examples of the saturated aliphatic hydrocarbon group represented by R¹ include a methyl group, an ethyl group, an n-propyl group, an isopropyl group, an n-butyl group, an isobutyl group, a sec-butyl group, a t-butyl group, an n-pentyl group, an isopentyl group, a sec-pentyl group, a neopentyl group, a t-pentyl group, an n-hexyl group, an n-heptyl group, an n-octyl group, an n-nonyl group, an n-decyl group, an n-eicosanyl group, and an n-triacontanyl group.

Examples of the unsaturated aliphatic hydrocarbon group represented by R¹ include an alkenyl group such as a vinyl group or an allyl group, and an alkynyl group such as an ethynyl group.

Examples of the alicyclic hydrocarbon group represented by R¹ include a cycloalkyl group such as a cyclopropyl group, a cyclobutyl group, a cyclopentyl group, a cyclohexyl group, a cycloheptyl group, a cyclooctyl group, a norbornyl group, or an adamantyl group and a cycloalkenyl group such as a cyclohexenyl group.

In Formula (II-1), R² is preferably a hydrocarbon group having 1 to 10 carbon atoms which may have a substituent, and from the viewpoint of reaction control, R² is more preferably a hydrocarbon group having 1 to 5 carbon atoms which may have a substituent. Examples of the hydrocarbon group represented by R² include the same as those exemplified as the hydrocarbon groups represented by R¹. m is preferably an integer from 0 to 2.

When the hydrocarbon group represented by R² has a substituent, examples of the substituent include a halogen atom, a hydroxyl group, an epoxy group, an oxetanyl group, an alkoxy group having 1 to 5 carbon atoms, and an acyl group having 2 to 5 carbon atoms. When the hydrocarbon group represented by R² has a substituent, the number of carbon atoms of the hydrocarbon group does not include the number of carbon atoms of the substituent.

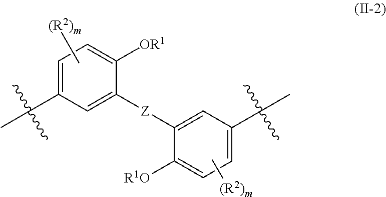

In Formula (II-2), each R¹ independently represents a hydrogen atom or a hydrocarbon group that has 1 to 30 carbon atoms and that may have a substituent; each R² independently represents a hydrocarbon group that has 1 to 30 carbon atoms and that may have a substituent; Z represents an oxygen atom or a divalent group represented by the following Formulae (III′-1) to (III′-7); and each m independently represents an integer from 0 to 3. Details of each of R′, R², and m in Formula (II-2) are the same as those of R′, R², and m in Formula (II-1).

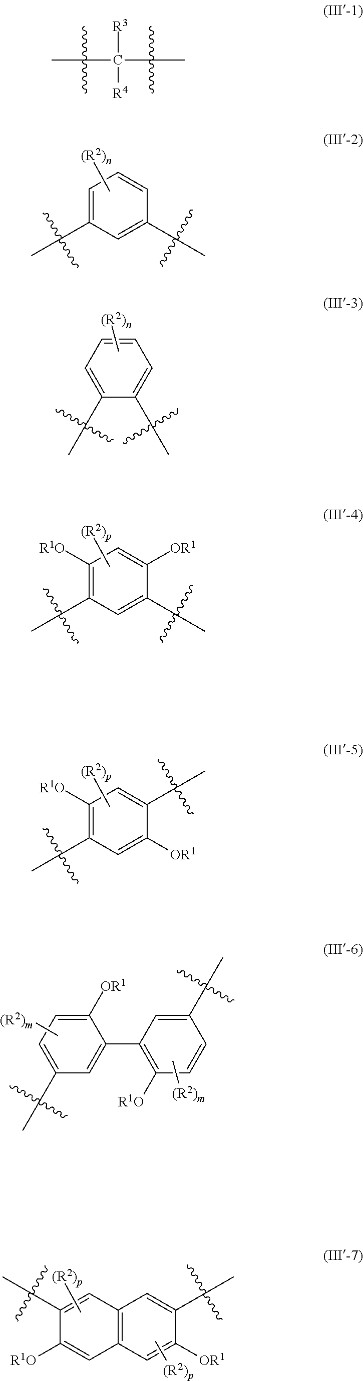

In Formulae (III′-1) to (III′-7), each R¹ independently represents a hydrogen atom or a hydrocarbon group that has 1 to 30 carbon atoms and that may have a substituent; each R² independently represents a hydrocarbon group that has 1 to 30 carbon atoms and that may have a substituent; R³ and R⁴ each independently represent a hydrogen atom or a hydrocarbon group that has 1 to 30 carbon atoms and that may have a substituent; each m independently represents an integer from 0 to 3; each n independently represents an integer from 0 to 4; and each p independently represents an integer from 0 to 2.

From the viewpoint of heat resistance, R³ and R⁴ in Formula (III′-1) are preferably a hydrocarbon group that has 1 to 5 carbon atoms and that may have a substituent. Examples of the hydrocarbon group having 1 to 30 carbon atoms represented by R³ or R⁴ include the same hydrocarbon groups having 1 to 30 carbon atoms as exemplified for R¹ in Formula (II-1). Examples of the substituent that R³ and R⁴ may have include a halogen atom, an alkoxy group having 1 to 5 carbon atoms, and an acyl group having 2 to 5 carbon atoms.

Each n in Formulae (III′-2) and (III′-3) independently represents an integer from 0 to 4, preferably an integer from 0 to 2, and more preferably 0 or 1.

Each p in Formulae (III′-4), (III′-5), and (III′-7) independently represents an integer from 0 to 2, and preferably 0 or 1.

The details of each of R′, R², and m in Formula (II-2) are the same as R′, R², and m in Formula (II-1).

When the hydrocarbon group represented by R³ or R⁴ has a substituent, Examples of the substituent include a halogen atom, a hydroxyl group, an epoxy group, an oxetanyl group, an alkoxy group having 1 to 5 carbon atoms, and an acyl group having 2 to 5 carbon atoms. When the hydrocarbon group represented by R³ or R⁴ has a substituent, the number of carbon atoms of the hydrocarbon group does not include the number of carbon atoms of the substituent.

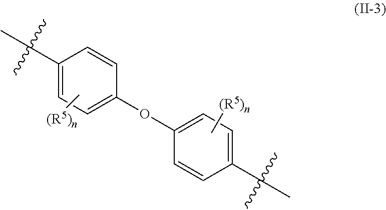

In Formula (II-3), each R⁵ independently represents a hydrocarbon group that has 1 to 30 carbon atoms and that may have a substituent; and each n independently represents an integer from 0 to 4.

From the viewpoint of heat resistance, R⁵ is preferably a hydrocarbon group which has 1 to 5 carbon atoms and which may have a substituent. Examples of the hydrocarbon group represented by R⁵ include the hydrocarbon groups represented by R¹ in Formula (II-1). Preferably, n is an integer from 0 to 2.

When the hydrocarbon group represented by R⁵ has a substituent, examples of the substituent include a halogen atom, a hydroxyl group, an epoxy group, an oxetanyl group, an alkoxy group having 1 to 5 carbon atoms, and an acyl group having 2 to 5 carbon atoms. When the hydrocarbon group represented by R⁵ has a substituent, the number of carbon atoms of the hydrocarbon group does not include the number of carbon atoms of the substituent.

In Formula (I-1), Y represents a divalent group having 5 to 50 carbon atoms, the divalent group containing an alicyclic ring and alkylene group each having 1 to 10 carbon atoms and connecting the carbon atoms contained in the carbonyl groups adjacent to Y and the alicyclic ring. In Formula (I-2), Y′ represents a divalent group having 3 to 50 carbon atoms and containing an alicyclic ring directly bonded to the carbon atoms contained in the carbonyl groups adjacent to Y′. From the viewpoint of heat resistance, each of the numbers of carbon atoms of Y and Y′ is preferably independently from 6 to 50.

In Formula (I-1), the alkylene groups each having 1 to 10 carbon atoms and connecting the alicyclic ring with the carbon atoms included in the carbonyl groups adjacent to Y is preferably independently a methylene group or an ethylene group, and more preferably a methylene group.

Examples of the structure of an alicyclic ring in Y or Y′ include a cyclopropane skeleton, a cyclobutane skeleton, a cyclopentane skeleton, a cyclohexane skeleton, a cycloheptane skeleton, a cyclooctane skeleton, a cuban skeleton, a norbornane skeleton, a tricyclo [5.2.1.0] decane skeleton, an adamantane skeleton, a diadamantane skeleton, a bicyclo [2.2.2] octane skeleton, and a decahydronaphthalene skeleton.

From the viewpoints of heat resistance and transparency, it is preferable that the structure of the alicyclic ring in Y and Y′ contains at least one selected from the group consisting of a cyclohexane skeleton, a decahydronaphthalene skeleton, an adamantane skeleton, a norbornane skeleton, and a bicyclo [2.2.2] octane skeleton.

From the viewpoint of heat resistance, it is more preferable that Y and Y′ each independently represent a divalent group containing at least one alicyclic ring selected from the group consisting of the following Formulae (III-1) to (III-5).

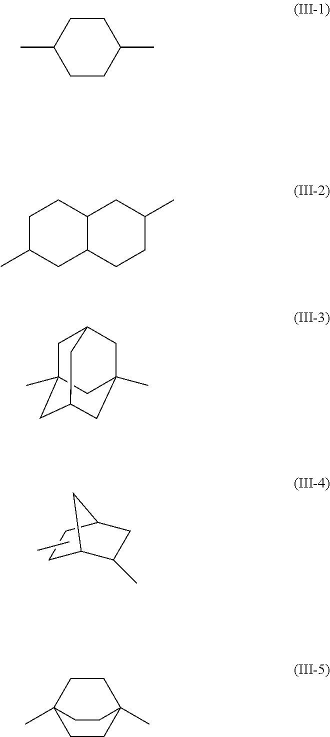

Examples of the divalent group containing an alicyclic ring represented by Formula (III-4) include alicyclic divalent groups represented by the following Formulae (III-4-1), (III-4-2), and (III-4-3).

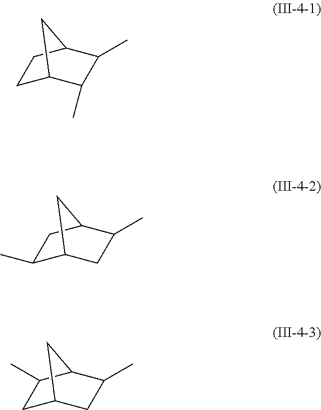

The molecular weight of the polymer according to an embodiment is not particularly limited, and may be selected according to the application and the like. From the viewpoint of heat resistance, the weight average molecular weight (Mw) of the polymer according to an embodiment is preferably 5,000 or more, and more preferably 10,000 or more. The number average molecular weight (Mn) thereof is preferably 1,000 or more, and more preferably 2,000 or more.

From the viewpoint of solubility in a solvent, the weight average molecular weight (Mw) of the polymer according to an embodiment is preferably 350,000 or less, and more preferably 300,000 or less. Further, the number average molecular weight (Mn) thereof is preferably 200,000 or less, and more preferably 100,000 or less.

The molecular weight (Mw or Mn) of the polymer according to embodiment is a value determined by standard polystyrene conversion as measured by a GPC method using tetrahydrofuran (THF) as an eluent.
Device name: Ecosec HLC-8320GPC (Tosoh Corporation)
Column: TSKgel Supermultipore HZ-M (Tosoh Corporation)
Detector: a UV detector and an RI detector are used in combination
Flow velocity: 0.4 ml/min

(Method of Producing Polymer)

The method of producing the polymer according to an embodiment is not particularly limited. For example, such a polymer may be produced by a method including: a step (hereinafter, also referred to as “reaction step”) of reacting a compound containing an aromatic ring (hereinafter, also referred to as “aromatic monomer”), a compound represented by the following Formula (IV-1) (hereinafter, also referred to as “dicarboxylic acid monomer A”), and a compound represented by the following Formula (IV-2) (hereinafter, also referred to as “dicarboxylic acid monomer B”) in an acidic medium.

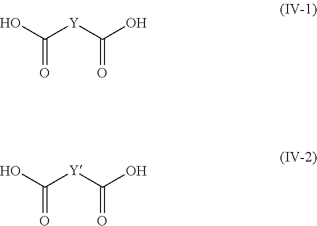

The details of Y and Y′ in Formulae (IV-1) and (IV-2) are the same as the details of Y and Y′ in Formulae (I-1) and (I-2).

From the viewpoints of heat resistance and transparency, the aromatic monomer preferably contains at least one selected from the group consisting of the following Formula (V-1), the following Formula (V-2), and the following Formula (V-3).

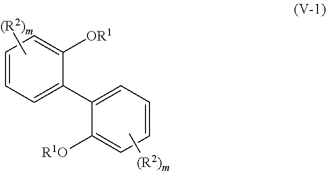

In Formula (V-1), each R¹ independently represents a hydrogen atom or a hydrocarbon group that has 1 to 30 carbon atoms and that may have a substituent; each R² independently represents a hydrocarbon group that has 1 to 30 carbon atoms and that may have a substituent; and each m independently represents an integer from 0 to 3.

The details of R′, R², and m in Formula (V-1) are the same as the details of R′, R², and m in Formula (II-1).

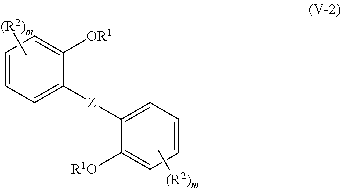

In Formula (V-2), each R¹ independently represents a hydrogen atom or a hydrocarbon group that has 1 to 30 carbon atoms and that may have a substituent; each R² independently represents a hydrocarbon group that has 1 to 30 carbon atoms and that may have a substituent; Z represents an oxygen atom or a divalent group represented by the following Formulae (III′-1) to (III′-7); and each m independently represent an integer from 0 to 3.

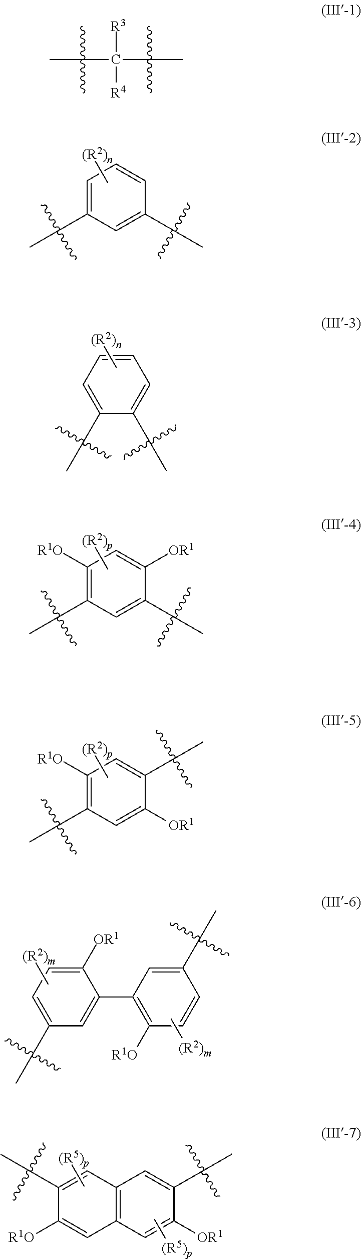

In Formulae (III′-1) to (III′-7), each R¹ independently represents a hydrogen atom or a hydrocarbon group that has 1 to 30 carbon atoms and that may have a substituent; each R² independently represents a hydrocarbon group that has 1 to 30 carbon atoms and that may have a substituent; R³ and R⁴ each independently represent a hydrogen atom or a hydrocarbon group that has 1 to 30 carbon atoms and that may have a substituent; each m independently represents an integer from 0 to 3; each n independently represents an integer from 0 to 4; and each p independently represents an integer from 0 to 2. The details of R¹, R², R³, R⁴, m, n, and p in Formulae (III′-1) to (III′-7) are the same as R¹, R², R³, R⁴, m, n, and p in Formulae (III′-1) to (III′-7) in Formula (II-2), respectively.

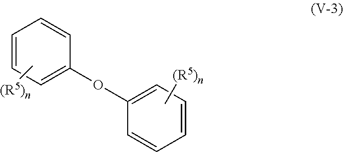

In Formula (V-3), each R⁵ independently represents a hydrocarbon group that has 1 to 30 carbon atoms and that may have a substituent; and each n independently represents an integer from 0 to 4.

The details of R⁵ and n in Formula (V-3) are the same as the details of R⁵ and n in Formula (II-3).

The acidic medium used in the above method is not particularly limited. Herein, the term “acidic medium” means a medium containing an acidic substance (Brönsted acid or Lewis acid), and the acidic substance may be an organic acid or an inorganic acid. The acidic medium is preferably in a liquid state under reaction conditions. For example, an organic solvent solution of aluminum chloride, an organic solvent solution of trifluoroalkanesulfonic acid, polyphosphoric acid, a mixture of diphosphorus pentoxide and an organic sulfonic acid, or the like may be used. From the viewpoints of reactivity and ease of handling, it is preferable to use a mixture of diphosphorus pentoxide and organic sulfonic acid as the acidic medium, and methanesulfonic acid is preferable as the organic sulfonic acid. An acidic medium may be used alone, or two or more kinds thereof may be used in combination.

When a mixture of diphosphorus pentoxide and an organic sulfonic acid is used as an acidic medium, the mixing ratio of diphosphorus pentoxide and the organic sulfonic acid in mass ratio (i.e., diphosphorus pentoxide:organic sulfonic acid) is preferably from 1:5 to 1:20, and more preferably from 1:5 to 1:10, from the viewpoints of control of mixing ratio and reactivity.

The amount of the acidic medium to be blended with respect to the total amount of an aromatic monomer, a dicarboxylic acid monomer A, and a dicarboxylic acid monomer B is not particularly limited as long as the dicarboxylic acid monomer A and dicarboxylic acid monomer B are capable of being dissolved, and the acidic medium may be used in a range from a catalytic amount to a solvent amount. From the viewpoints of reactivity and ease of handling, the amount to be blended is preferably in the range of from 5 parts by mass to 100 parts by mass with respect to 1 part by mass of the total of the dicarboxylic acid monomer A and the dicarboxylic acid monomer B.

The temperature of reaction in a condensation reaction between the aromatic monomer and the dicarboxylic acid monomer A and the dicarboxylic acid monomer B is preferably from 10° C. to 100° C. from the viewpoint of suppressing coloration of a reaction product and side reaction, and more preferably from 20° C. to 100° C. from the viewpoint of increasing a reaction rate to improve productivity.

The reaction atmosphere in the condensation reaction between the aromatic monomer and the dicarboxylic acid monomer A and the dicarboxylic acid monomer B is not particularly limited, and the reaction may be carried out in a closed system or an open system. From the viewpoint of suppressing a decrease in the reactivity of the acidic medium due to the presence of moisture, the reaction atmosphere is preferably dry air or an inert gas atmosphere of nitrogen, argon, or the like. From the viewpoint of preventing unexpected side reactions, an inert gas atmosphere of nitrogen, argon, or the like is more preferable.

During the reaction of the aromatic monomer with the dicarboxylic acid monomer A and the dicarboxylic acid monomer B, the acidic medium containing these monomers may be stirred to accelerate the reaction. The method of stirring is not particularly limited, and the stirring can be carried out by a general method using a magnetic stirrer, a mechanical stirrer, or the like.

The time for reacting the aromatic monomer with the dicarboxylic acid monomer A and the dicarboxylic acid monomer B may be controlled by the reaction temperature, the molecular weight of a target polymer, the type of monomer used in the reaction, or the like. The reaction time is preferably from about 1 hour to 120 hours from the viewpoint of obtaining a polymer having a satisfactory large molecular weight, and is more preferably from 1 hour to 72 hours from the viewpoint of productivity.

The pressure at the time of reacting the aromatic monomer with the dicarboxylic acid monomer A and the dicarboxylic acid monomer B is not particularly limited, and the reaction may be carried out either under normal pressure, under pressure, or under reduced pressure. From the viewpoint of cost, it is preferable to carry out the reaction under atmospheric pressure.

The method of taking out the polymer after the reaction of the aromatic monomer with the dicarboxylic acid monomer A and the dicarboxylic acid monomer B is not particularly limited. For example, a reaction solution (acidic catalyst containing a reaction product) and a poor solvent for a polymer as the reaction product may be brought into contact with each other to precipitate the polymer, impurities may be extracted into the poor solvent phase, and the precipitated polymer may be separated and taken out from the reaction solution by filtration, decantation, centrifugation, or the like. After that, a step of dissolving the separated polymer again in a good solvent for the polymer, bringing the solution again into contact with a poor solvent for the polymer to precipitate the polymer, extracting impurities into a poor solvent phase, and separating the precipitated polymer from the liquid by a method such as filtration, decantation, or centrifugation may be repeated.

When a target polymer is obtained by separating it from a liquid by filtration, decantation, centrifugation, or the like, a solvent may remain in the polymer. Accordingly, the polymer may be dried if necessary. The method of drying is not particularly limited, and may be carried out by a method such as vacuum drying, heat vacuum drying, natural drying, hot air drying, heat drying, high frequency drying, or dehumidification drying.

<Composition>

The composition according to an embodiment includes the polymer according to an embodiment of the invention. The state of the composition is not particularly limited, and may be selected according to the use of the composition or the like. Examples of the state of the composition include a varnish, a slurry, and a mixed powder. The composition according to an embodiment may contain another component in addition to the polymer according to an embodiment. Examples of the other component include a solvent, an additive, and a crosslinking agent.

Examples of the additive include an adhesion aid, a surfactant, a leveling agent, an antioxidant, and an ultraviolet deterioration inhibitor. These additives may be used singly, or two or more kinds thereof may be used in combination.

Examples of the crosslinking agent include a polyfunctional epoxy compound, a polyfunctional acrylic compound, a polyfunctional oxetane compound, a compound having plural hydroxyl groups, a compound having plural hydroxymethyl groups, and a compound having plural alkoxymethyl groups. These crosslinking agents may be used singly, or two or more kinds thereof may be used in combination.

Examples of the solvent include γ-butyrolactone, ethyl lactate, propylene glycol monomethyl ether acetate, butyl acetate, benzyl acetate, ethoxyethyl propionate, 3-methyl methoxypropionate, N-methyl-2-pyrrolidone, N-cyclohexyl-2-pyrrolidone, N,N-dimethylformamide, N,N-dimethyl acetamide, dimethyl sulfoxide, hexamethylphosphorylamide, tetramethylene sulfone, diethyl ketone, diisobutyl ketone, methyl amyl ketone, cyclohexanone, propylene glycol monomethyl ether, propylene glycol monopropyl ether, propylene glycol monobutyl ether, dipropylene glycol monomethyl ether, xylene, mesitylene, ethylbenzene, propylbenzene, cumene, diisopropylbenzene, hexylbenzene, anisole, diglyme, dimethyl sulfoxide, chloroform, dichloromethane, dichloroethane, and chlorobenzene. These solvents may be used singly, or two or more kinds thereof may be used in combination.

<Film and Film-Bearing Substrate>

The film according to an embodiment includes the polymer according to an embodiment of the invention. The film according to an embodiment is more flexible and has more excellent heat resistance than a film containing a polymer obtained by polymerizing an aromatic monomer and a single kind of alicyclic dicarboxylic acid monomer.

The method of producing the film according to an embodiment is not particularly limited. For example, the film according to an embodiment may be produced by applying the composition according to an embodiment containing a solvent to the surface of a substrate to form a composition layer and, if necessary, drying the substrate to remove the solvent from the composition layer. The produced film may be used as a film-bearing substrate without being separated from the substrate, or may be used after being separated from the substrate.

The method of applying the composition to a substrate is not particularly limited, and examples thereof include a dipping method, a spray method, a screen printing method, a bar coating method, and a spin coating method. The method of drying the composition layer is not particularly limited, and examples thereof include a method of heating using a hot plate, an oven or the like, and natural drying.

If necessary, the dried polymer film according to an embodiment may be subjected to an additional heat treatment. The method of heat treatment is not particularly limited, and may be carried out using an oven such as a box dryer, a hot air conveyor dryer, a quartz tube furnace, a hot plate, a rapid thermal annealing, a vertical diffusion furnace, an infrared curing furnace, an electron beam curing furnace, or a microwave curing furnace. As the atmospheric conditions in the heat treatment step, any of atmosphere or an inert atmosphere such as nitrogen can be selected.

The film-bearing substrate according to an embodiment of the invention has: a substrate; and the film according to an embodiment provided on at least a part of the surface of the substrate. The film-bearing substrate according to an embodiment may have a film on one side of the substrate or may have a film on both sides of the substrate. The film formed on a substrate may have a single layer structure or a multilayer structure in which two or more layers are stacked.

The type of the substrate is not particularly limited. Examples of the substrate include: an inorganic substrate such as a glass substrate, a semiconductor substrate, a metal oxide insulator substrate (such as a titanium oxide substrate or a silicon oxide substrate), or a silicon nitride substrate; and a resin substrate of triacetylcellulose, polyimide, polycarbonate, acrylic resin, cycloolefin resin, or the like. The substrate may be transparent, or may be not transparent. The shape of the substrate is not particularly limited, and examples thereof include a plate shape and a film shape.

<Optical Element and Image Display Device>

Each of the optical element and image display device according to embodiments of the invention has the film or film-bearing substrate according to embodiments of the invention.

Optical elements and image display devices may be obtained, for example, by bonding a substrate on which the film according to an embodiment has been formed on the substrate side to a member used for LCDs (liquid crystal displays), ELDs (electroluminescence displays), or the like via an adhesive, a glue, or the like.

The optical element according to an embodiment may be preferably used as a polarizing plate or the like for various image display devices such as a liquid crystal display device. The image display device may have the same configuration as a conventional image display device, except that the film according to an embodiment is used. When the image display device is a liquid crystal display device, the liquid crystal display device may be produced by appropriately assembling respective components such as a liquid crystal cell, a polarizing plate, and other optical elements and, if necessary, a lighting system (backlight etc.), and incorporating a driving circuit. The type of liquid crystal cell is not particularly limited, and TN type, STN type, π type, or the like may be used.

The application of the image display device is not particularly limited. Examples of the application of the image display device include office automation equipment such as a desktop personal computer, a notebook computer, or a copy machine, mobile devices such as a mobile phone, a watch, a digital camera, a personal digital assistant (PDA), or a portable game machine, a household electric appliance such as a video camera, a television, a microwave oven, automotive equipment such as a back monitor, a car navigation system monitor, or a car audio, exhibition equipment such as a monitor for information for commercial store, security equipment such as a monitor for monitoring, nursing care equipment such as a nursing care monitor, and a medical equipment such as a medical monitor.

<Coating Material>

The coating material according to an embodiment of the invention includes the polymer according to an embodiment of the invention. A target to be coated with the coating material is not particularly limited, and examples thereof include office automation equipment such as a desktop personal computer, a notebook computer, or a copy machine, a mobile device such as a mobile phone, a digital camera, a personal digital assistant (PDA), or a portable game machine, a video camera, a television, various displays, window glass, car glass, a camera lens. The method of forming a coating using the coating material is not particularly limited, and for example, a coating may be formed by adhering the film-like coating material to a target to be coated by a method such as lamination, or a coating may be formed by applying a liquid coating material to a target to be coated and then drying the target.

<Molded Article>

The molded article according to an embodiment of the invention includes the polymer according to an embodiment of the invention. The method of producing the molded article is not particularly limited, and a method known in the art may be used. Examples of such a method include an extrusion molding method, an injection molding method, a calender molding method, a blow molding method, a fiber reinforced plastic (FRP) molding method, a laminating molding method, a casting method, a powder molding method, a solution casting method, a vacuum forming method, an air-pressure forming method, an extrusion composite molding method, a stretch molding method, and a foam molding method.

Various additives may be added to the molded article according to an embodiment, if necessary, for imparting desired functions, improving properties, improving moldability, or the like. Examples of the additive include a sliding agent (such as polytetrafluoroethylene particles), a light diffusing agent (such as acrylic crosslinked particles, silicone crosslinked particles, ultrathin glass flakes, or calcium carbonate particles), a fluorescent dye, an inorganic fluorescent substance (such as a fluorescent substance having aluminate as a mother crystal), an antistatic agent, a crystal nucleating agent, an inorganic or organic antimicrobial agent, a photocatalyst-based antifouling agent (such as titanium oxide particles, or zinc oxide particles), a crosslinking agent, a curing agent, a reaction accelerator, an infrared absorbing agent (such as heat absorbing agent), and a photochromic agent.

### EXAMPLES

Hereinafter, the invention will be described in detail with reference to Examples, but the invention is not limited to these Examples.

(1) Synthesis of Polymer

The monomers shown in Table 1 and Table 2 were placed in a flask in the amounts (mmol) shown in Table 1 and Table 2, 30 ml of a mixed solution of diphosphorus pentoxide and methanesulfonic acid (mass ratio 1:10) was added thereto, and the mixture was stirred for 15 hours at 60° C. with a nitrogen balloon. After the reaction, the reaction solution was poured into 500 ml of methanol, and the formed precipitate was collected by filtration. The obtained solid was washed with distilled water and methanol and then dried, thereby obtaining a polymer (aromatic polyketone). The weight average molecular weight (Mw) and the number average molecular weight (Mn) of the obtained polymer were determined by GPC method using tetrahydrofuran (THF) as an eluent and converted by standard polystyrene. Details are as follows.
Device name: Ecosec HLC-8320GPC (Tosoh Corporation)
Column: TSKgel Supermultipore HZ-M (Tosoh Corporation)
Detector: UV detector and RI detector are used in combination
Flow velocity: 0.4 ml/min

(2) Evaluation of Transparency

The obtained polymer was dissolved in 1-methyl-2-pyrrolidone (NMP) to a concentration of 20% by mass and filtered with a membrane filter made of polytetrafluoroethylene (pore diameter 5 μm), thereby obtaining a polymer composition (varnish). This varnish was applied on a glass substrate by a bar coating method and dried on a hot plate heated to 120° C. for 3 minutes, thereby producing a film-bearing glass substrate. This film-bearing glass substrate was heat-treated at 200° C. for 1 hour in an inert gas oven purged with nitrogen, and then, the transmittance at a wavelength of 400 nm was measured by ultraviolet-visible absorption spectrum method using a UV-visible spectrophotometer (“U-3310 Spectrophotometer” Hitachi High-Tech Co., Ltd.). Tables 1 and 2 show the transmittance (%) in terms of film thickness of 1 μm, using a glass substrate without the film as a reference. The film thickness was taken as an arithmetic mean value of values measured at three points using a stylus profilometer (“Dektak 3ST”, ULVAC, Inc. (Veeco)).

(3) Evaluation of Heat Resistance

The same varnish used for evaluation of transparency was applied on a polyimide (Kapton) film by a bar coating method and dried on a hot plate heated to 120° C. for 3 minutes, thereby producing a polyimide substrate with a film of the polymer. The film was peeled off from the polyimide substrate and heat-treated at 200° C. for 1 hour in an inert gas oven purged with nitrogen. Thereafter, the glass transition temperature of the film was measured by a dynamic viscoflexibility measurement method (tensile mode) using a dynamic viscoflexibility measuring device (“RSA-II” Rheometrics Inc.). Tables 1 and 2 show the obtained values (° C.) of the glass transition temperature. In Table 1 and Table 2, “X” indicates that the film was brittle and the measurement with the dynamic viscoflexibility measuring device was not able to be conducted.

(4) Evaluation of Flexibility (Flex Resistance)

Flexibility was evaluated by a mandrel test (cylindrical mandrel method) using the same film-bearing polyimide substrate as that produced for evaluation of heat resistance. The test was carried out according to JIS K5600-5-1:1999. The diameter of the mandrel was varied from 25 mm to 3 mm, and the presence or absence of a crack was visually confirmed. Tables 1 and 2 show the minimum value (mm) of the diameter of the mandrel when no crack is generated. It can be evaluated that superior flexibility is attained when the minimum value of the diameter of the mandrel is smaller.

Details of the monomers used in the synthesis of the polymer in Examples and Comparative Examples are as follows.

Aromatic monomer
2,2′-dimethoxy biphenyl

Dicarboxylic acid monomer A
1,3-adamantane diacetic acid

Dicarboxylic acid monomer B-1
cis-1,4-cyclohexane dicarboxylic acid

Dicarboxylic acid monomer B-2
trans-1,4-cyclohexane dicarboxylic acid

Dicarboxylic acid monomer B-3

Mixture of cis-1,4-cyclohexane dicarboxylic acid and trans-1,4-cyclohexane dicarboxylic acid (cis:trans=7:3 based on mass ratio)

Dicarboxylic acid monomer B-4
Decalin-2,6-dicarboxylic acid

Dicarboxylic acid monomer B-5
1,3-adamantane dicarboxylic acid

Dicarboxylic acid monomer B-6

Mixture of 2,5-norbornane dicarboxylic acid and 2,6-norbornane dicarboxylic acid

Dicarboxylic acid monomer B-7
trans-2,3-norbornane dicarboxylic acid

TABLE 1

| | Example 1 | Example 2 | Example 3 | Example 4 | Example 5 | Example 6 | Example 7 |
|---|---|---|---|---|---|---|---|
| Aromatic monomer | 10 | 10 | 10 | 10 | 10 | 10 | 10 |
| Dicarboxylic acid monomer A | 9 | 8 | 7 | 6 | 5 | 4 | 3 |
| Dicarboxylic acid monomer B-1 | 1 | 2 | 3 | 4 | 5 | 6 | 7 |
| Dicarboxylic acid monomer B-2 | — | — | — | — | — | — | — |
| Dicarboxylic acid monomer B-3 | — | — | — | — | — | — | — |
| Dicarboxylic acid monomer B-4 | — | — | — | — | — | — | — |
| Dicarboxylic acid monomer B-5 | — | — | — | — | — | — | — |
| Dicarboxylic acid monomer B-6 | — | — | — | — | — | — | — |
| Dicarboxylic acid monomer B-7 | — | — | — | — | — | — | — |
| Mw | 35,000 | 37,000 | 34,000 | 39,000 | 45,000 | 38,000 | 36,000 |
| Mn | 11,000 | 10,000 | 12,000 | 10,000 | 11,000 | 11,000 | 10,000 |
| Transmittance [%] | 98 | 98 | 98 | 98 | 98 | 97 | 97 |
| Glass transition point [° C.] | 190 | 194 | 200 | 204 | 209 | 214 | 219 |
| Mandrel test core rod diameter | 3 | 3 | 3 | 3 | 3 | 5 | 5 |
| [mm] | | | | | | | |

| | Example 8 | Example 9 | Example 10 | Example 11 | Example 12 | Example 13 |
|---|---|---|---|---|---|---|
| Aromatic monomer | 10 | 10 | 10 | 10 | 10 | 10 |
| Dicarboxylic acid monomer A | 5 | 5 | 5 | 5 | 5 | 5 |
| Dicarboxylic acid monomer B-1 | — | — | — | — | — | — |
| Dicarboxylic acid monomer B-2 | 5 | — | — | — | — | — |
| Dicarboxylic acid monomer B-3 | — | 5 | — | — | — | — |
| Dicarboxylic acid monomer B-4 | — | — | 5 | — | — | — |
| Dicarboxylic acid monomer B-5 | — | — | — | 5 | — | — |
| Dicarboxylic acid monomer B-6 | — | — | — | — | 5 | — |
| Dicarboxylic acid monomer B-7 | — | — | — | — | — | 5 |
| Mw | 37,000 | 33,000 | 33,000 | 38,000 | 27,000 | 26,000 |
| Mn | 10,000 | 11,000 | 10,000 | 9,500 | 9,200 | 8,100 |
| Transmittance [%] | 98 | 98 | 99 | 99 | 99 | 99 |
| Glass transition point [° C.] | 212 | 206 | 219 | 218 | 216 | 216 |
| Mandrel test core rod diameter | 3 | 3 | 3 | 7 | 5 | 5 |
| [mm] | | | | | | |

TABLE 2

| | Reference | Comparative | Comparative | Comparative | Comparative | Comparative | Comparative | Comparative |
|---|---|---|---|---|---|---|---|---|
| | Example 1 | Example 1 | Example 2 | Example 3 | Example 4 | Example 5 | Example 6 | Example 7 |
| Aromatic | 10 | 10 | 10 | 10 | 10 | 10 | 10 | 10 |
| monomer | | | | | | | | |
| Dicarboxylic | 10 | — | — | — | — | — | — | — |
| acid | | | | | | | | |
| monomer A | | | | | | | | |
| Dicarboxylic | — | 10 | — | — | — | — | — | — |
| acid | | | | | | | | |
| monomer B-1 | | | | | | | | |
| Dicarboxylic | — | — | 10 | — | — | — | — | — |
| acid | | | | | | | | |
| monomer B-2 | | | | | | | | |
| Dicarboxylic | — | — | — | 10 | — | — | — | — |
| acid | | | | | | | | |
| monomer B-3 | | | | | | | | |
| Dicarboxylic | — | — | — | — | 10 | — | — | — |
| acid | | | | | | | | |
| monomer B-4 | | | | | | | | |
| Dicarboxylic | — | — | — | — | — | 10 | — | — |
| acid | | | | | | | | |
| monomer B-5 | | | | | | | | |
| Dicarboxylic | — | — | — | — | — | — | 10 | — |
| acid | | | | | | | | |
| monomer B-6 | | | | | | | | |
| Dicarboxylic | — | — | — | — | — | — | — | 10 |
| acid | | | | | | | | |
| monomer B-7 | | | | | | | | |
| MW | 42,000 | 20,000 | 21,000 | 24,000 | 21,000 | 17,000 | 26,000 | 21,000 |
| Mn | 12,000 | 8,000 | 8,600 | 11,000 | 10,000 | 7,800 | 12,000 | 9,000 |
| Transmittance | 99 | 96 | 95 | 96 | 99 | 99 | 99 | 99 |
| [%] | | | | | | | | |
| Glass | 183 | x | x | x | x | x | x | x |
| transition | | | | | | | | |
| point [° C.] | | | | | | | | |
| Mandrel test | 3 | 25 | 25 | 25 | 25 | 25 | 25 | 25 |
| core rod | | | | | | | | |
| diameter | | | | | | | | |
| [mm] | | | | | | | | |

As shown in Tables 1 and 2, all of the films produced from the polymers of Examples which were synthesized using an aromatic monomer and two dicarboxylic acid monomers showed favorable transparency. Films made from the polymers of Examples had superior flexibility than those of the films made from the polymers of Comparative Examples which were synthesized using an aromatic monomer and one dicarboxylic acid monomer.

The film produced from the polymer of Reference Example which was synthesized using an aromatic monomer and 1,3-adamantane dicarboxylic acid as a dicarboxylic acid monomer had flexibility equivalent to those of Examples, but the glass transition temperature was lower than those of Examples, and the heat resistance was inferior to those of Examples.

From the above results, it is understood that the polymer according to embodiments of the invention has excellent transparency, heat resistance, and flexibility.

The disclosure of Japanese Patent Application No. 2016-116086 is hereby incorporated by reference in its entirety. All Documents, Patent Applications, and technical standards described herein are incorporated by reference herein to the same extent as if each of the Documents, Patent Applications, and technical standards had been specifically and individually indicated to be incorporated by reference.

1. A polymer, comprising:
a structural unit represented by the following Formula (I-1); and
a structural unit represented by the following Formula (I-2): 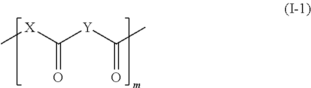
wherein, in Formula (I-1), X represents a divalent group comprising 6 to 50 carbon atoms and an aromatic ring; Y represents a divalent group comprising 5 to 50 carbon atoms, the divalent group comprising an alicyclic ring and alkylene groups, and the alkylene groups each having 1 to 10 carbon atoms and connecting carbon atoms included in carbonyl groups adjacent to Y with the alicyclic ring; and m represents an integer from 3 to 1,000; and 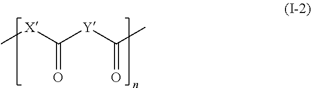
wherein, in Formula (I-2), X′ represents a divalent group comprising 6 to 50 carbon atoms and an aromatic ring; Y′ represents a divalent group comprising 3 to 50 carbon atoms and an alicyclic ring directly bonded to carbon atoms included in carbonyl groups adjacent to Y′; and n represents an integer from 3 to 1,000.

2. The polymer according to claim 1, wherein, in Formula (I-1) and Formula (I-2), each of X and X′ independently has from 12 to 50 carbon atoms.

3. The polymer according to claim 1, wherein X and X′ in Formulae (I-1) and (I-2) each independently represents a group represented by at least one selected from the group consisting of the following Formula (II-1), the following Formula (II-2), and the following Formula (II-3): 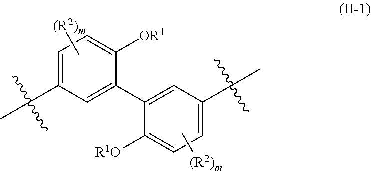
wherein, in Formula (II-1), each R¹ independently represents a hydrogen atom or a hydrocarbon group that comprises 1 to 30 carbon atoms and that may comprise a substituent; each R² independently represents a hydrocarbon group that comprises 1 to 30 carbon atoms and that may comprise a substituent; and each m independently represents an integer from 0 to 3; 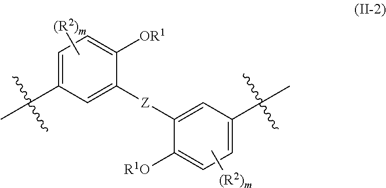
wherein, in Formula (II-2), each R¹ independently represents a hydrogen atom or a hydrocarbon group that comprises 1 to 30 carbon atoms and that may comprise a substituent; each R² independently represents a hydrocarbon group that comprises 1 to 30 carbon atoms and that may comprise a substituent; Z represents an oxygen atom or a divalent group represented by the following Formulae (III′-1) to (III′-7); and each m independently represents an integer from 0 to 3; 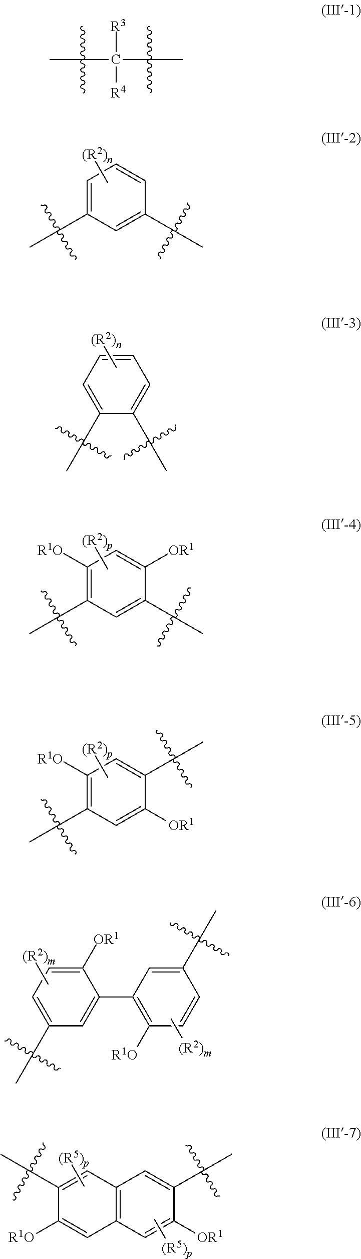
wherein, in Formulae (III′-1) to (III′-7), each R¹ independently represents a hydrogen atom or a hydrocarbon group that comprises 1 to 30 carbon atoms and that may comprise a substituent; each R² independently represents a hydrocarbon group that comprises 1 to 30 carbon atoms and that may comprise a substituent; R³ and R⁴ each independently represent a hydrogen atom or a hydrocarbon group that comprises 1 to 30 carbon atoms and that may comprise a substituent; each m independently represents an integer from 0 to 3; each n independently represents an integer from 0 to 4; and each p independently represents an integer from 0 to 2; and 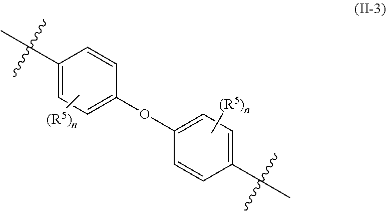
wherein, in Formula (II-3), each R⁵ independently represents a hydrocarbon group that comprises 1 to 30 carbon atoms and that may comprise a substituent; and each n independently represents an integer from 0 to 4.

4. The polymer according to claim 1, wherein, in Formulae (I-1) and (I-2), each of Y and Y′ independently has from 6 to 50 carbon atoms.

5. The polymer according to claim 1, wherein, in Formulae (I-1) and (I-2), the structure of each alicyclic ring in Y and Y′ independently comprises at least one selected from the group consisting of a cyclohexane skeleton, a decahydronaphthalene skeleton, an adamantane skeleton, a norbornane skeleton, and a bicyclo [2.2.2] octane skeleton.

6. The polymer according to claim 1, wherein, in Formulae (I-1) and (I-2), each of Y and Y′ independently comprises at least one alicyclic ring selected from the group consisting of the following Formulae (III-1) to (III-5):

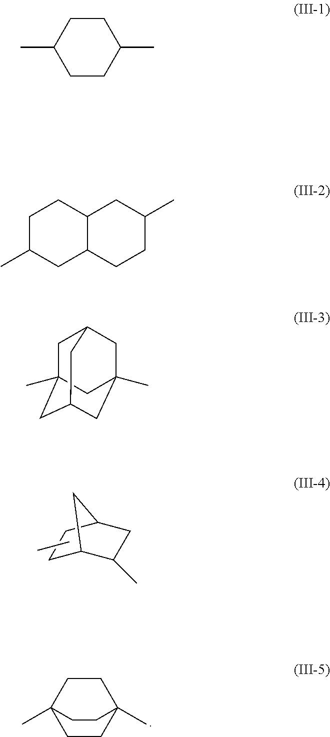

7. A composition, comprising the polymer according to claim 1.

8. The composition according to claim 7, further comprising a solvent.

9. A film, comprising the polymer according to claim 1.

10. A film-bearing substrate, comprising:
a substrate; and
the film according to claim 9, which is provided on at least a part of a surface of the substrate.

11. An optical element, comprising the film according to claim 9.

12. An image display device, comprising the film according to claim 9.

13. A coating material, comprising the polymer according to claim 1.

14. A molded article, comprising the polymer according to claim 1.

15. An optical element, comprising the film-bearing substrate according to claim 10.

16. An image display device, comprising the film-bearing substrate according to claim 10.
